(19) United States
(12) Patent Application Publication
(10) Pub. No.: US 2021/0387577 A1
(43) Pub. Date: Dec. 16, 2021

(54) Magnetic Device Mount for Attachment to Non-Ferromagnetic Material

(71) Applicant: Jonathan Mark MORGAN, Biscayne Park, FL (US)

(72) Inventor: Jonathan Mark MORGAN, Biscayne Park, FL (US)

(21) Appl. No.: 17/343,195

(22) Filed: Jun. 9, 2021

Related U.S. Application Data
(60) Provisional application No. 63/037,464, filed on Jun. 10, 2020.

(51) Int. Cl. B60R 11/02

(52) U.S. Cl. CPC B60R 11/0241; B60R 2011/0026

(57) ABSTRACT

The invention relates to an apparatus with magnets of a unique configuration to secure devices to non-ferromagnetic material, such as the windshield of a car. The invention permits the perimeter structure of the non-ferrous material to optionally be used to provide additional stability to secured devices. At least two magnets clamp opposite sides of the non-ferromagnetic material, magnetically associating the two magnets. The magnets are of a shape conducive to avoiding collision with windshield wipers, when mounted onto a car windshield, while maintaining sufficient volume to provide acceptable magnetic force to support devices mechanically attached to magnets. Example attached devices include a phone, GPS, camera, or tablet.

### CROSS REFERENCE TO RELATED APPLICATION

This application claims the benefit of provisional U.S. Application No. 63/037,464 entitled “Magnetic Device Mount for Attachment to Non-Ferromagnetic Material” filed Jun. 10, 2020, the technical disclosure of which is hereby incorporated by reference in its entirety.

### BACKGROUND OF THE INVENTION

### Technical Field

The present invention relates to an apparatus for mounting a device to non-ferromagnetic material.

### Description of Related Art

Known methods of mounting devices, such as phones, GPS, and camera, inside a car include securing devices to the vehicle windshield with suction cups or adhesive, mechanically clamping to the dashboard or vehicle air conditioner vents, or utilizing the vehicle's cup holder or CD player receptacles for mechanical attachment.

Known solutions are prone to failure, as adhesives and suction cups easily lose attachment to the vehicle, causing the potentially costly supported device to fall and become damaged. Suction cups and adhesives often do not permit detachment from one vehicle and reattachment to a second vehicle, as the suction and adhesive properties are diminished after only a few detachment and reattachment cycles. Large environmental temperature variations easily weaken suction cup and adhesive attachment.

Known solutions that mechanically clamp to the vehicle may also not provide secure attachment, or they may be incompatible with many vehicles. Mounts that are secured to the vehicle air conditioner vents may fail, as vehicle air vents may be unable to support the clamping and weight load of the prior art. Mounts that require attachment to a vehicle cup holder or the CD receptacle of a vehicle CD player may not be compatible with many vehicles due to non-existent or inconvenient location of cup holder or CD player.

Embodiments of the disclosed invention minimize the failures and incompatibilities associated with existing solutions.

### SUMMARY OF THE INVENTION

The present invention is directed to a method and apparatus for removably mounting a device to a non-ferromagnetic material, such as the windshield of a car. In one embodiment, the apparatus is a mount comprising a first and a second magnet that physically contacts opposite sides of a non-ferromagnetic material. The opposing magnetic poles of the magnets provide a magnetic attractive force that clamps opposing magnet poles to the non-ferromagnetic material. The magnetic force prevents the magnets, as well as devices attached to said magnets from falling due to gravity or perturbation. The magnets may be composed of magnetic materials that resist demagnetization with exposure to high temperatures. Heat resistant magnets are critical when the present invention is used in outdoor climates, where devices in direct sunlight may exceed 160 degrees Fahrenheit. Further, an optional weather resistant coating on said magnets prevents magnets from oxidizing and provides additional friction between the magnets and the non-ferromagnetic material. The additional friction prevents lateral motion of the magnets relative to the non-ferromagnetic material. An extension arm may be attached to the first and/or the second magnet. A device holder, potentially a clamp or magnet, is attached to the extension arm. A device, such as a cellular phone, GPS, camera, or computer tablet may be removably attached to said device holder. As a result, said device is removably attached to the ferromagnetic material. The magnetic force between the first and the second magnet supports in full or in part the mass of the device and the apparatus of the present invention. The device remains attached to the non-ferromagnetic material, despite gravitation pull and external disturbances. Additionally, the present invention provides features that may physically contact structure protruding normal to the non-ferromagnetic material. Physical contact of the present invention with the protruding structure provides additional rocking and lateral motion stability. The present invention may also include an integrated storage compartment to store the second magnet for ease of travel.

The invention surprisingly overcomes several problems that have not been solved in the prior art, including the long felt need for a method for stable and reliable attachment of a mount to a non-ferromagnetic material. The solution disclosed and claimed

JMORG.00002 Page 2 U.S. Patent Application herein provides superior performance to devices known in the art, at a similar or lower cost than devices known in the art.

In one embodiment, a magnetic mounting device comprises: a first magnet; a second magnet; an extension arm attached to the first magnet; and a device clamp attached to the extension arm at an end opposite from the first magnet. In another embodiment, the first magnet and second magnet are coated with a plastic or rubber coating. In another embodiment, the first magnet is shaped to be fitted to an edge of a vehicle windshield in contact a vehicle A pillar. In another embodiment, the first magnet is offset horizontally from the extension arm. In another embodiment, the extension arm includes a hollow portion configured to store the second magnet. In another embodiment, the second magnet fits within the extension arm and leaves an air gap between the first magnet and the second magnet. In another embodiment, the first magnet and second magnet are high temperature resistant magnets. In another embodiment, the first magnet and second magnet each have a maximum working temperature above 200 degrees Fahrenheit. In another embodiment, the extension arm is configured to contact a vehicle windshield at an end opposite the device clamp.

In one embodiment, a method of mounting a mobile device on a vehicle windshield comprises: attaching a mobile device to a device clamp, wherein the device clamp is attached to an extension arm, and wherein the extension arm is attached to a first magnet; attaching the first magnet to an interior side of the vehicle windshield by placing a second magnet within an attractive distance of the first magnet on an exterior side of the vehicle windshield. In another embodiment, the method further comprises placing the first magnet in contact with a vehicle A pillar.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a perspective view of one embodiment of the present invention

FIG. 2 is a different perspective view of another embodiment of the present invention, shown beside a lateral support structure, in this case a vehicle A Pillar.

FIG. 3 is a perspective view of another embodiment of the present invention, shown while supporting an electronic device and beside a lateral support structure.

FIG. 4 is an environmental view of another embodiment of the present invention, with a preferred mounting location shown on a vehicle.

FIG. 5 is the top view of another embodiment of the present invention, with a horizontal offset between the mount's first magnet and the extension arm.

FIG. 6 is a rear perspective view of another embodiment of the present invention with the second magnet in a storage compartment.

FIG. 7 is an exploded view of another embodiment of the present invention with the second magnet in a storage compartment.

### DETAILED DESCRIPTION

The present invention is directed to a method and apparatus for removably mounting a device to a non-ferromagnetic material. In one embodiment, the present invention is mounted to a windshield, such as the windshield of a car or boat, and the device attached to the present invention is a phone, GPS, tablet, or camera. Generically, the present invention may be mounted to any non-ferromagnetic material, and the attached device may be any device of a weight that may be supported in part or in full by the magnetic forces of the present invention.

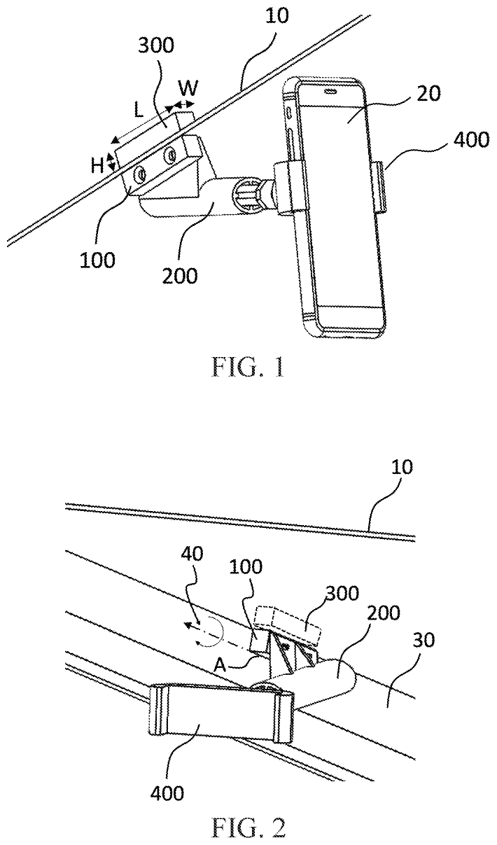

FIG. 1. depicts the present invention attached to a sheet of non-ferromagnetic material. A cellular phone is also supported by the present invention. A first magnet (100) is placed onto one surface of a non-ferromagnetic material (10). A second magnet (300) is placed on the opposite side of the non-ferromagnetic material (10), and is magnetically attracted to the opposing magnetic pole of said first magnet (100). First and second magnets may themselves be composed of smaller magnets, mechanically or magnetically joined to one another.

The first and second magnets may be identical or different size and shape relative to one another. While rectangular is the preferred shape of the first and second magnet, shapes may vary.

One or both magnets (100 & 300) may be coated and/or hermetically sealed to prevent corrosion. Examples of coating materials include rubber or plastic. Further, a coating may be used to provide friction between magnets (100 & 300) and non-ferromagnetic material (10). The friction, if sufficiently large, may prevent unwanted lateral movement of said magnets relative to one another and non-ferromagnetic material (10). The lateral direction is perpendicular to the direction of the normal force between opposing north and south poles of magnets (100 & 300). The coating thickness is selected appropriately, such that air gap between magnets is minimized. Air gaps decrease magnetic forces between magnet pairs. Further, magnet coating material may be temperature resistant such that the coating does not fail, including failure by melting or cracking, with exposure to high or low environmental temperature extremes.

The magnetic force between the magnets is sufficient to support the weight of one or both magnets, as well as the weight of parts and devices attached to said magnets. Further, the magnetic forces may be sufficiently high to prevent the present invention with attached device from detaching from non-ferromagnetic material (10) due to perturbation. Perturbation may be induced from external static loads or dynamic loads. Magnets are of a material and material grade, such as neodymium N48 grade, that offer relatively high magnetic force for a given magnet volume.

The material and grade of the magnets of present invention (100 & 300) may also be selected such that magnetic forces are not significantly diminished due to high temperature. Examples of high temperature resistant magnets include neodymium grade AH or AE series magnets, or samarium-cobalt magnets. High temperature resistance is critical if the present invention is to be used on a vehicle windshield in a warm climate, where vehicles in direct sunlight may exceed 160 degrees Fahrenheit. In some embodiments, a heat resistant magnet will have a maximum working temperature above 200 degrees Fahrenheit. As used herein, the maximum working temperature is defined as the temperature at which a magnet starts to lose its strength if it continues to be heated. Use of heat resistant magnets is not described or appreciated in relevant prior art.

First magnet (100) is connected to an extension arm (200) and device clamp (400). In this embodiment, a cell phone (20) is secured to the present invention with the device clamp (400). The device clamp permits the cell phone to be attached to and detached from the present invention. The mount can support more weight on the device clamp when the distance between the device clamp and the magnet is shorter.

Generally, the present invention may include any number of other parts, other than said extension and device clamp, that permits a device to be connected to first magnet (100), and thus to the non-ferromagnetic material. For example, said extension arm (200) may be rigid or flexible. A flexible extension arm may be bent into a desired shape or orientation with respect to the first magnet or device clamp.

Further, in a different embodiment, said device clamp (400) may be replaced by a third magnet that can support the weight of the attached device (20) via magnetic coupling to the device, or to ferromagnetic material attached to said device. Said extension arm and clamp may be combined to create one rigid part, or additional joints may be added to the assembly between first magnet and cell phone to permit the cell phone orientation and/or position to achieve additional range. Further, one or more devices may be connected to first or second magnet.

Though the preferred embodiment of FIG. 1 depicts the present invention holding a cell phone, any other mobile device that can be supported by the present invention may instead be held. For example, the present invention may secure to the non-ferromagnetic material a computer tablet, a GPS, or a camera.

FIGS. 2 and 3 depict the preferred embodiment of the present invention, with the present invention attached to a non-ferromagnetic material (10), in this case a vehicle glass windshield, with the use of the magnetic force provided by the first magnet (100) and second magnet (300). FIG. 3 shows a phone mounted to the present invention. FIG. 2 does not include a mounted device. The first magnet of FIGS. 2 and 3 is in direct physical contact with a vehicle A pillar (30) at magnet corner (A). Physical contact with the A pillar prevents unwanted lateral motion, in the direction toward the vehicle A pillar. Further, contact with the A pillar provides a contact reaction force that prevents unwanted rocking of the present invention about the rocking axis (40) shown in FIG. 2. Without such prevention of rocking, the weight of the present invention and potentially external loads, may induce rocking motion of the present invention about rocking axis (40). The present invention is designed with appropriate shape and dimensions to be fitted to the edge of a vehicle windshield, in order to contact the vehicle A pillar.

In addition to the mount of the present invention providing means to physically contact the vehicle A pillar for stability, the first magnet may be magnetically coupled to ferromagnetic material on or inside the vehicle A pillar. Such magnetic coupling provides additional stability to the present invention. With sufficient magnet force between the first magnet and the vehicle A pillar, the present invention can remain attached to vehicle if the second magnet is removed from the exterior of the vehicle windshield.

In addition, the end of the extension arm 200 that is opposite the device clamp 400 may be configured to contact the vehicle windshield when the invention is attached to a vehicle windshield. This additional contact provides an additional force moment that counteracts the force moment from the weight of a device attached to the device clamp, which allows the mount to support heavier devices attached to the clamp.

While FIGS. 2 and 3 depict the preferred embodiment of attachment to a vehicle A pillar and glass windshield, the present invention may be attached to a structure other than a vehicle. More broadly, the present invention may be attached to any non-ferromagnetic. Further, unwanted lateral and rocking motion of the present invention may be mitigated by physical contact or magnetic coupling with any structure protruding from said non-ferromagnetic material.

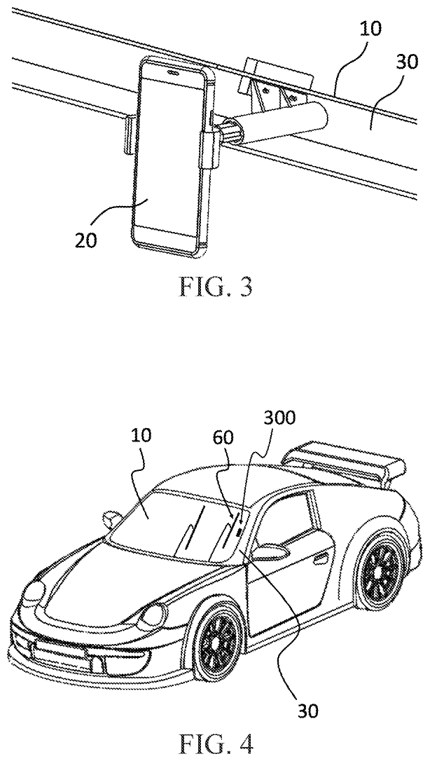

The preferred embodiment of the mount of the present invention includes attachment of second magnet (300) to the edge of a vehicle windshield, as shown in FIG. 4. Second magnet includes a minimum width, w, as shown in FIG. 1 to allow vehicle windshield wipers (60) to avoid collision with second magnet. The windshield wipers of most vehicles on the market do not reach to the horizontal edges of vehicle windshields. The second magnet, though, is of sufficient volume to provide magnetic force sufficient to support the weight of the present invention and the attached device (20). Second magnet dimensions L and H offset the minimum width w, as shown in FIG. 1.

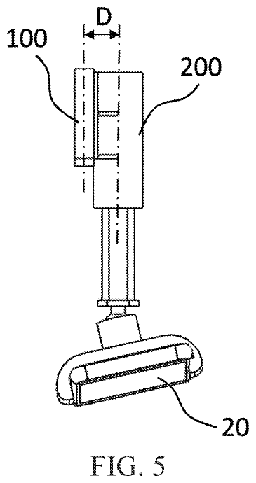

The first magnet (100) of the present invention may be offset horizontally from the extension arm by dimension D, as depicted in FIG. 5. The offset permits installation in many vehicles that otherwise would not be viable for installation. Said offset allows the first magnet to be fitted to the edge of the vehicle windshield, without experiencing collision of the vehicle A pillar with the present invention. Placement of the first magnet at the windshield edge results in the second magnet being secured at the exterior windshield edge, which avoids collision between the windshield wipers and the second magnet.

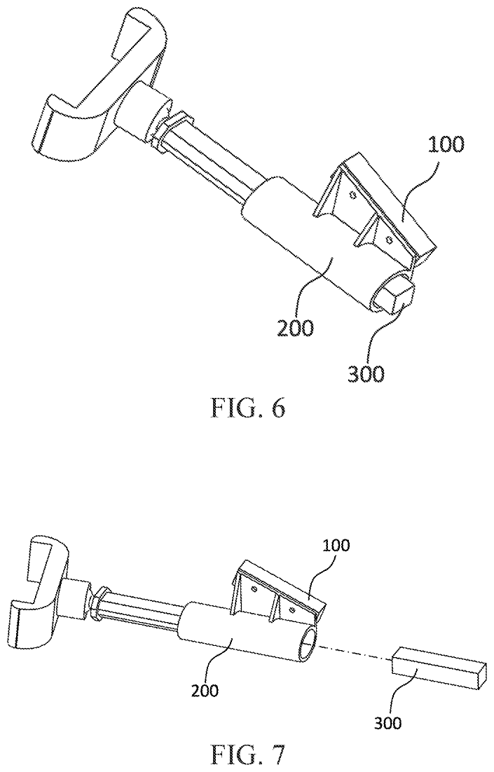

The present invention may include integrated storage for the second magnet (300), permitting the present invention to be conveniently packed for travel. FIG. 6 depicts the second magnet stored within a hollowed portion of the extension arm (200). An exploded view of the second magnet in its storage configuration is shown in FIG. 7. The second magnet storage compartment contains and supports the second magnet, preventing it from separating from the extension arm, due to gravitational forces on the second magnet. The location of the second magnet storage compartment may vary from the position of FIG. 6. The storage compartment may also be located sufficiently close to the first magnet, such that the magnetic forces between first and second magnets prevents the second magnet from dislodging from the second magnet storage compartment. The second magnet storage compartment, though, may be a sufficient distance from the first magnet, such that an air gap between the magnets results in a reduced magnetic attraction between the first and second magnet. The reduced magnetic force permits a user to easily remove the second magnet from its storage compartment. Otherwise, with first and second magnets stored too close to one another, a pinching hazard may result when a user handles the magnets. Forces between the magnets may cause magnets to quickly attract one another, and user's fingers may be pinched between the clamping forces of the two magnetically coupled magnets.

It will now be evident to those skilled in the art that there has been described herein a mount that can be removably attached to a non-ferromagnetic surface, with the use of magnetic forces. Although the invention hereof has been described by way of preferred embodiments, it will be evident that other adaptations and modifications can be employed without departing from the spirit and scope thereof. The terms and expressions employed herein have been used as terms of description and not of limitation; and thus, there is no intent of excluding equivalents, but on the contrary it is intended to cover any and all equivalents that may be employed without departing from the spirit and scope of the invention.

In sum, while this invention has been particularly shown and described with reference to a preferred embodiment, it will be understood by those skilled in the art that various changes, in form and detail may be made therein without departing from the spirit and scope of the invention.

I claim:

1 A magnetic mounting device comprising:
a first magnet;
a second magnet;
an extension arm attached to the first magnet;
a device clamp attached to the extension arm at an end opposite from the first magnet.

2. The mounting device of claim 1 wherein the first magnet and second magnet are coated with a plastic or rubber coating.

3. The mounting device of claim 1 wherein the first magnet is shaped to be fitted to an edge of a vehicle windshield in contact a vehicle A pillar.

4. The mounting device of claim 1 wherein the first magnet is offset horizontally from the extension arm.

5. The mounting device of claim 1 wherein the extension arm includes a hollow portion configured to store the second magnet.

6. The mounting device of claim 5 wherein the second magnet fits within the extension arm and leaves an air gap between the first magnet and the second magnet.

7. The mounting device of claim 1 wherein the first magnet and second magnet are high temperature resistant magnets.

8. The mounting device of claim 1 wherein the first magnet and second magnet each have a maximum working temperature above 200 degrees Fahrenheit.

9. The mounting device of claim 1 wherein the extension arm is configured to contact a vehicle windshield at an end opposite the device clamp.

10. A method of mounting a mobile device on a vehicle windshield comprising:
attaching a mobile device to a device clamp, wherein the device clamp is attached to an extension arm, and wherein the extension arm is attached to a first magnet;
attaching the first magnet to an interior side of the vehicle windshield by placing a second magnet within an attractive distance of the first magnet on an exterior side of the vehicle windshield.

11. The method of mounting a mobile device on a vehicle windshield of claim 10 further comprising placing the first magnet in contact with a vehicle A pillar.
